(19) United States
(12) Patent Application Publication
(10) Pub. No.: US 2009/0099127 A1
(43) Pub. Date: Apr. 16, 2009

(54) Nematicidal Compositions and Methods

(75) Inventors: Michael R. Schwarz, Raleigh, NC (US); John E. Curtis, Cantonment, FL (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: BAYER CROPSCIENCE LP, RESEARCH TRIANGLE PARK, NC (US)

(21) Appl. No.: 12/092,051

(22) PCT Filed: Oct. 31, 2006
(86) PCT No.: PCT/US2006/042457

§ 371 Date: Aug. 13, 2008

(30) Foreign Application Priority Data
Nov. 1, 2005 (US) 11/264683

(51) Int. Cl. A01N 43/16; A01N 43/40; A01N 47/12; A01N 43/88; A01N 37/18

(52) U.S. Cl. 514/53; 514/341; 514/477; 514/229.2; 514/365

(57) ABSTRACT

A nematicidal composition includes (a) at least one carbamate and (b) at least one neonicotinoid and/or chloronicotinyle. In one exemplary embodiment, the carbamate can be an oxime carbamate, such as thiodicarb and the neonicotinoid can be a nitroguanidine. In one specific embodiment, the nitroguanidine includes imidacloprid and/or clothianidin. An exemplary method of the invention includes applying a composition of the invention to either soil or a plant (e.g., seeds or foliarly) to combat nematode damage and/or increase crop yield.

### BACKGROUND OF THE INVENTION

1. Field of the Invention

The present invention relates generally to pest control compositions and methods and, in one particular embodiment, to compositions and methods particularly useful for combating nematodes and/or increasing crop yield.

2. Description of the Current Technology

Nematodes are tiny, worm-like, multicellular animals adapted to living in water. The number of nematode species is estimated at half a million. An important part of the soil fauna, nematodes live in a maze of interconnected channels, called pores, that are formed by soil processes. They move in the films of water that cling to soil particles. Plant-parasitic nematodes, a majority of which are root feeders, are found in association with most plants. Some are endoparasitic, living and feeding within the tissue of the roots, tubers, buds, seeds, etc. Others are ectoparasitic, feeding externally through plant walls. A single endoparasitic nematode can kill a plant or reduce its productivity. Endoparasitic root feeders include such economically important pests as the root-knot nematodes (Meloidogyne species), the reniform nematodes (Rotylenchulus species), the cyst nematodes (Heterodera species), and the root-lesion nematodes (Pratylenchus species). Direct feeding by nematodes can drastically decrease a plant's uptake of nutrients and water. Nematodes have the greatest impact on crop productivity when they attack the roots of seedlings immediately after seed germination. Nematode feeding also creates open wounds that provide entry to a wide variety of plant-pathogenic fungi and bacteria. These microbial infections are often more economically damaging than the direct effects of nematode feeding.

Current nematode control focuses essentially on the prevention of nematode attack on the plant. Once a plant is parasitized it is virtually impossible to kill the nematode without also destroying the plant. Therefore, it would be advantageous to provide nematode control compositions and methods of treating plants to prevent or reduce nematode damage.

### SUMMARY OF THE INVENTION

A nematicidal composition comprises (a) at least one carbamate and (b) at least one neonicotinoid and/or chloronicotinyle. In one exemplary embodiment, the carbamate can be an oxime carbamate, such as thiodicarb and the neonicotinoid can be a nitroguanidine. In one specific embodiment, the nitroguanidine comprises imidacloprid and/or clothianidin.

An exemplary method of the invention comprises applying a composition of the invention to either soil or a plant (e.g., seeds or foliarly) to combat nematode damage and/or increase crop yield.

### BRIEF DESCRIPTION OF THE DRAWINGS

FIG. 1 is a graph of juvenile counts (Rotylenchulus reniformis) per liter of soil 75 days after planting for cotton plants treated as set forth in Table 8;

FIG. 2 is a graph of % Abbott (tomato root knot nematodes) 43 days after planting for tomato plants based on a 0-10 gall rating where 0=no galling and 10=100% of the root surface galled;

FIG. 3 is a graph of reniform nematodes per pint of soil for Example 5;

FIG. 4 is a graph of root galling for cotton plants as described in Example 5;

FIG. 5 is a graph of root-know nematodes per 500 cc of soil for cotton plants as described in Example 5; and

FIG. 6 is a graph of nematodes per 500 cc of soil for four locations as described in Example 5.

### DESCRIPTION OF THE PREFERRED EMBODIMENTS

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. All references referred to herein are to be understood as being incorporated by reference in their entirety. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.5, 5.5 to 10, 2.3 to 7.3, etc.

Nematicidal compositions of the invention will first be described and then methods of utilizing the nematicidal compositions will be discussed.

An exemplary nematicidal composition of the invention comprises (a) at least one carbamate and (b) at least one neonicotinoid and/or chloronicotinyle.

As will be appreciated by one skilled in the art, carbamates act by competing with acetylcholine and binding to the active sites of cholinesterase. As a result, acetylcholine is not degraded by the enzyme, and levels accumulate, leading to increased firing of the postsynaptic neurons. In structure, carbamate pesticides vary from lipophilic to hydrophilic. Examples of carbamates suitable for the present invention include, but are not limited to, thiodicarb, methomyl, methiocarb, carbaryl, and aldicarb. In one particular non-limiting embodiment, the carbamate is an oxime carbamate, such as thiodicarb.

The composition also includes one or more neonicotinoid and/or chloronicotinyle. Examples of suitable neonicotinoids and chloronicotinyles include, but are not limited to, nitroguanidines (e.g., imidacloprid, thiamethoxam, clothianidin, and dinotefuran), nitromethylenes (e.g., nitenpyram), cyanamidines (e.g., acetamiprid and thiacloprid), chloropyridines, chlorothiazoles, and tetrahydrofuranes.

In one non-limiting embodiment, the composition is an aqueous composition comprising thiodicarb and imidacloprid. The thiodicarb and imidacloprid can be present in any desired amount. In one non-limiting embodiment, the thiodicarb is present in the range of greater than 0 to 1,000 grams active per liter (g a/l), e.g., 50 to 800 g a/l, e.g., 100 to 600 g a/l, e.g., 200 to 500 g a/l, e.g., 300 to 400 g a/l. The imidacloprid can be present in any desired amount, such as in the range of greater than 0 to 1,000 g a/l, e.g., 50 to 800 g a/l, e.g., 100 to 800 g a/l, e.g., 200 to 800 g a/l, e.g., 300 to 700 g a/l, e.g., 400 to 700 g a/l, e.g., 500 to 700 g a/l.

In another non-limiting embodiment, the composition comprises thiodicarb, imidacloprid, and clothianidin. The thiodicarb, imidacloprid, and clothianidin can be present in any desired concentration, such as greater than 0 up to 1,000 g a/l for each component. In one non-limiting embodiment, the thiodicarb and imidacloprid can be present in the ranges discussed above. The clothianidin can be present in the amount of 50 to 800 g a/l, e.g., 50 to 700 g a/l, e.g., 50 to 500 g a/l, e.g., 100 to 300 g a/l, e.g., 100 to 200 g a/l.

The compositions of the invention are particularly useful in combating plant-parasitic nematodes, for example, Pratylenchus spp., Radopholus similis, Ditylenchus dipsaci, Tylenchulus semipenetrans, Heterodera spp., Globodera spp., Meloidogyne spp., Rotylenchulus spp., Aphelenchoides spp., Longidorus spp., Xiphinema spp., Trichodorus spp. and Bursaphelenchus spp. The compounds according to the invention can be used with particularly good results for controlling plant-damaging nematodes, such as, for example, against Meloidogyne incognita and Rotylenchulus reniformis.

At certain concentrations or application rates, the compositions according to the invention may, if appropriate, also be used as herbicides and microbicides, for example as fungicides, antimycotics and bactericides. If appropriate, they may also be used as intermediates or precursors for the synthesis of further active compounds.

All plants and plant parts can be treated in accordance with the invention. “Plants” are to be understood as meaning in the present context all plants and plant populations such as desired and undesired wild plants or crop plants (inclusive of naturally occurring crop plants). Crop plants can be plants which can be obtained by conventional plant breeding and optimization methods or by biotechnological and recombinant methods or by combinations of these methods, inclusive of the transgenic plants and inclusive of the plant cultivars protectable or not protectable by plant breeders' rights. “Plant parts” are to be understood to mean all above-ground and underground parts and organs of plants, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offsets and seeds.

As already mentioned above, it is possible to treat all plants and their parts according to the invention. In one embodiment, wild plant species and plant cultivars, or those obtained by conventional biological breeding, such as crossing or protoplast fusion, and parts thereof, are treated. In a further embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above.

Plants of the plant cultivars which are in each case commercially available or in use can be treated according to the invention. Plant cultivars are to be understood as meaning plants having novel properties (“traits”) which can be obtained by conventional breeding, by mutagenesis or by recombinant DNA techniques. This can be varieties, bio- and genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions to be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which can be treated according to the invention include all plants which, in the genetic modification, received genetic material which imparted particularly advantageous useful traits to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defense of the plants against animal and microbial pests, such as against nematodes, insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapevines), and particular emphasis is given to maize, soya beans, potatoes, cotton, tomatoes, and oilseed rape.

Treatment according to the invention of the plants and plant parts with the composition is carried out directly or by allowing the compounds to act on their surroundings, environment or storage space by the customary treatment methods, for example by immersion, spraying, evaporation, fogging, scattering, painting on and, in the case of propagation material, in particular in the case of seed, also by applying one or more coats.

The active compounds can be converted into the customary formulations, such as solutions, emulsions, wettable powders, suspensions, powders, dusts, pastes, soluble powders, granules, suspension-emulsion concentrates, natural and synthetic materials impregnated with active compound, and microencapsulations in polymeric substances.

These formulations are produced in a known manner, for example by mixing the active compounds with extenders, that is liquid solvents and/or solid carriers, optionally with the use of surfactants, that is emulsifiers and/or dispersants, and/or foam-formers.

If the extender used is water, it is also possible to employ for example organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

As solid carriers there are suitable:

for example ammonium salts and ground natural minerals such as kaolins, clays, talc, chalk, quartz, attapulgite, montmorillonite or diatomaceous earth, and ground synthetic minerals, such as highly disperse silica, alumina and silicates; as solid carriers for granules there are suitable: for example crushed and fractionated natural rocks such as calcite, marble, pumice, sepiolite and dolomite, and also synthetic granules of inorganic and organic meals, and granules of organic material such as sawdust, coconut shells, maize cobs and tobacco stalks; as emulsifiers and/or foam-formers there are suitable: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; as dispersants there are suitable: for example lignin-sulphite waste liquors and methylcellulose.

Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations. Other additives can be mineral and vegetable oils.

It is possible to use colorants such as inorganic pigments, for example iron oxide, titanium oxide and Prussian Blue, and organic dyes, such as alizarin dyes, azo dyes and metal phthalocyanine dyes, and trace nutrients such as salts of iron, manganese, boron, copper, cobalt, molybdenum and zinc.

The formulations generally comprise between 0.1 and 95% by weight of active compound, preferably between 0.5 and 90%.

The compositions according to the invention can be present in their commercially available formulations and in the use forms, prepared from these formulations, as a mixture with other active compounds, such as insecticides, attractants, sterilizing agents, bactericides, acaricides, nematicides, fungicides, growth-regulating substances, herbicide safeners, or herbicides. Examples of such other active compounds are described in U.S. Pat. No. 6,927,215 B2 (column 10, line 58 to column 15, line 7); U.S. Pat. No. 6,423,823 B1 (column 13, line 39 to column 16, line 50); U.S. Pat. No. 6,930,076 B2 (column 7, line 28 to column 1, line 62); and U.S. Pat. No. 6,716,874 B1 (column 16, line 39 to column 21, line 34).

A mixture with other known active compounds, such as herbicides, or with fertilizers and growth regulators is also possible.

Use of the composition will now be discussed. The composition can be applied in any conventional method, such as by powder, in furrow, foliarly, microencapsulated, as a wettable powder, or as a seed treatment.

For example, in an exemplary seed treatment method, an aqueous composition comprising thiodicarb and imidacloprid can be applied at a rate to provide in the range of greater than 0 to 1,000 gram active thiodicarb per 100 Kg of seeds, e.g., 50 to 900 g a, e.g., 100 to 900 g a, e.g., 300 to 800 g a, e.g., 400 to 800 g a, e.g., 500 to 750 g a; and greater than 0 to 500 gram active imidacloprid per 100 kilograms of seeds, e.g., 50 to 500 g a, e.g., 100 to 500 g a, e.g., 200 to 400 g a, e.g., 300 to 400 g a, e.g., 350 g a. The thiodicarb and imidacloprid can be supplied from a single composition or can be supplied from separate compositions, e.g., one composition containing thiodicarb and a separate composition containing imidacloprid.

In another non-limiting embodiment, the composition can comprise thiodicarb, imidacloprid, and clothianidin. The thiodicarb and imidacloprid can be metered to provide the grams active per 100 Kg of seeds described above. The clothianidin can be metered to provide greater than 0 to 500 gram active clothianidin per 100 kilograms of seed e.g., 50 to 400 g a, e.g., 50 to 300 g a, e.g., 50 to 200 g a, e.g., 100 to 200 g a, e.g., 150 g a. In one particular embodiment, the thiodicarb is metered to provide 500 to 750 grams active thiodicarb per 100 kilograms seed and the imidacloprid and clothianidin are metered to provide a combined total of 500 grams active per 100 kilograms seed of imidacloprid and clothianidin. In a specific embodiment, the various components of the composition are selected to provide a combined total of 1,000 to 1,250 grams active of thiodicarb, imidacloprid, and clothianidin per 100 kilograms seed. Again, the thiodicarb, imidacloprid, and clothianidin can be supplied from a single composition or can be supplied from multiple compositions, e.g., one composition containing thiodicarb, another composition containing imidacloprid, and another composition containing clothianidin. Alternatively, some of the components may be combined, for example, one composition may contain thiodicarb while a separate composition can contain a mixture of imidacloprid and clothianidin.

Another nematicidal composition of the invention comprises a neonicotinoid, a carbamate, and abamectin. In one specific embodiment, the neonicotinoid can be any of the neonicotinoids discussed above, such as, for example, imidicloprid. The carbamate can be any of the carbamates discussed above, such as, for example, thiodicarb. The components can be present in any desired amounts. For example, the neonicotinoid and carbamate can be present in any of the amounts discussed above. In one nonlimiting embodiment, the abamectin can be present in an amount up to 0.25 mg of active ingredient per seed, such as up to 0.15 mg active ingredient per seed.

The general concepts of the invention are described in the following examples, which are not to be considered as limiting.

### EXAMPLE 1

This example illustrates the effect of a composition of the invention on cotton plant damage and plant height for cotton plants planted in soil known to have nematode (Rotylenchulus reniformis) pressure. The cotton plants utilized were commercially available Delta and Pineland variety 555.

The compositions described in Table 1 below were applied either as a seed treatment (Samples B, C, and E-G) or in furrow (Sample D) at the respective application rates set forth in Table 1.

TABLE 1

| | | g a/100 kg | | |
|---|---|---|---|---|
| Sample # | Composition | seed | lbs/acre | ga/hectre |
| A | none | | | |
| B | imidacloprid | 500 | | |
| C | imidacloprid/thiodicarb | 250/1,000 | | |
| D | aldicarb | | 3.5 | 588 |
| E | imidacloprid | 250 | | |
| F | imidacloprid/abamectin | 500/100 | | |
| G | imidacloprid/spinosad | 500/500 | | |

Table 2 illustrates the Thrips damage ratings at three and four weeks after planting. In this document, a Thrips damage rating of 1 indicates no damage to the plant and a Thrips damage rating of 5 indicates that the plant was completely damaged, i.e., dead.

TABLE 2
Thrips Damage Rating

| Sample # | 3 weeks | 4 weeks |
|---|---|---|
| A | 3.38 | 3.6 |
| B | 2 | 2.3 |
| C | 2 | 2.5 |
| D | 1.13 | 1.5 |
| E | 2.25 | 2.4 |
| F | 1.88 | 2.3 |
| G | 2.38 | 2.1 |

Table 3 shows the average plant height seven weeks after planting.

TABLE 3

| | Plant Height |
|---|---|
| Sample # | (inches/cm) |
| A | 24/61 |
| B | 29.5/74.9 |
| C | 29.5/74.9 |
| D | 30.3/77 |
| E | 29.5/74.9 |
| F | 29.3/74.4 |
| G | 29/73.7 |

The above Example shows that the composition of the invention reduces plant damage under the conditions tested.

### EXAMPLE 2

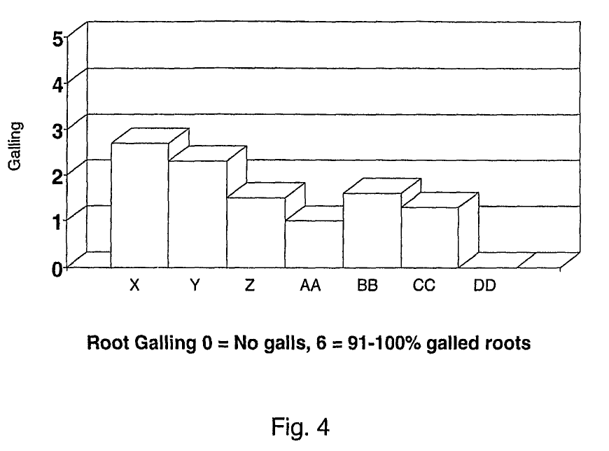

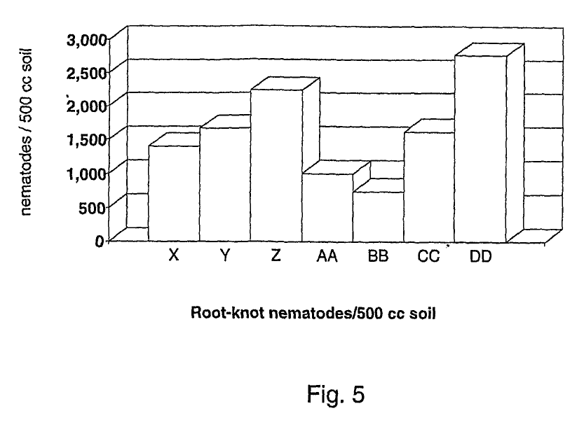

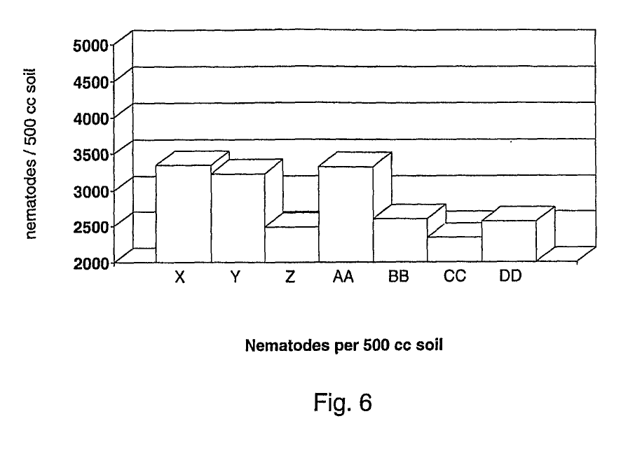

This example illustrates the effect of the compositions from Table 1 for cotton plants planted in soil known to have nematode (Rotylenchulus reniformis) pressure. FIGS. 4 and 5 illustrate the Thrips damage ratings at three and four weeks, respectively, after planting. FIG. 6 illustrates the plant height seven weeks after planting. The cotton plants utilized were commercially available Fibermax cotton variety 960.

Table 4 illustrates the Thrips damage ratings at three and four weeks after planting.

TABLE 4
Thrips Damage Rating

| Sample # | 3 weeks | 4 weeks |
|---|---|---|
| A | 4.38 | 4.3 |
| B | 2.63 | 2.5 |
| C | 3.13 | 2.6 |
| D | 2.5 | 2.1 |
| E | 2.88 | 3 |
| F | 2.75 | 2.5 |
| G | 2.75 | 2.8 |

Table 5 shows the average plant height seven weeks after planting.

TABLE 5

| | Plant Height |
|---|---|
| Sample # | (inches/cm) |
| A | 19.3/49 |
| B | 29.3/74.4 |
| C | 28.3/71.9 |
| D | 27.8/70.6 |
| E | 28.5/72.4 |
| F | 28.8/73.2 |
| G | 27.3/69.3 |

Again, this Example illustrates that the composition of the invention reduces plant damage under the conditions tested.

### EXAMPLE 3

This example illustrates the effect of compositions of the invention on cotton yield.

Cotton plants were treated as set forth in Table 6 to determine the impact on cotton yield. The plants were planted in soil known to have nematode (Rotylenchulus reniformis) pressure.

TABLE 6

| | | g a/100 kg | | ga/ |
|---|---|---|---|---|
| Sample # | Compositions | seed | lbs in furrow | hectre |
| H | None (control) | N/A | | |
| I | aldicarb | | 5 | 840 |
| J | aldicarb | | 5.0 (plus | |
| | | | 5.0 lbs. | |
| | | | side-dress) | |
| K | aldicarb | | 7.0 | 1176 |
| L | imidacloprid | 500 | | |
| M | imidacloprid/abimectin | 500/100 | | |
| N | imidacloprid/thiodicarb | 250/1,000 | | |

Table 7 illustrates the yield of cotton lint per acre obtained after treatment with the compositions of Table 6.

TABLE 7

| | Cotton lint |
|---|---|
| | Yield per Acre |
| Sample # | (lbs/Kg) |
| H (control) | 1277/597 |
| I | 1276/578.8 |
| J | 1609/729 |
| K | 1380/626 |
| L | 1454/659.5 |
| M | 1546/701 |
| N | 1607/729 |

As can be seen from Table 7, treating the cotton seeds with the present invention (Sample Q) provided a significantly increased yield over no treatment and better or equivalent yield compared with the other treatments.

### EXAMPLE 4

This Example illustrates the effect of a composition of the invention against different nematode varieties.

Table 8 lists the compositions tested in this Example.

TABLE 8

| Sample # | Compositions | g a/100 kg seed | ga/hectre |
|---|---|---|---|
| O | None (control) | | |
| P | imidacloprid | 250 | |
| Q | imidacloprid | 500 | |
| R | imidacloprid/abamectin | 500/100 | |
| S | imidacloprid/thiodicarb | 250/350 | |
| T | imidacloprid/spirosad | 250/250 | |
| U | clothianidin/imidacloprid | 250/250 | |
| V | clothianidin/imidacloprid | 150/350 | |
| W | aldicarb | | 840 |

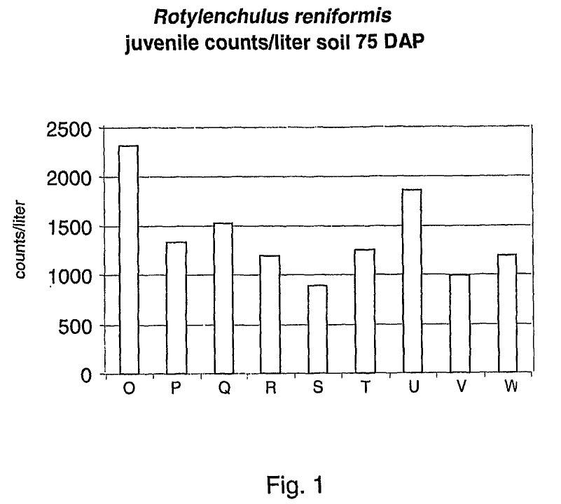

FIG. 1 shows the juvenile counts per liter of soil 75 days after planting for cotton plants in soil known to have Rotylenchulus reniformis pressure. Sample S of the invention showed significantly lower counts than the other samples.

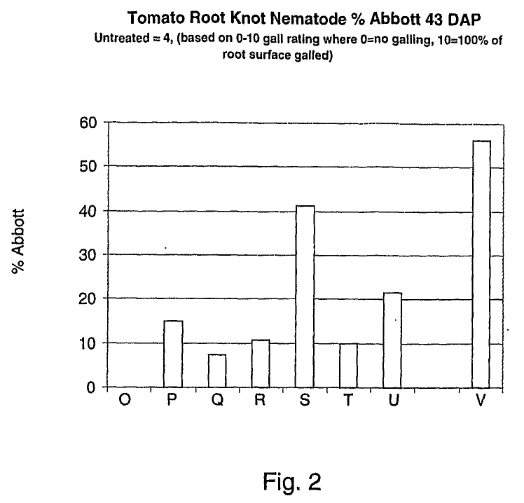

FIG. 2 shows the % Abbott 43 days after planting for tomato plants in soil known to have pressure from tomato root knot nematodes. The composition S of the invention provided the best reduction in galling of the seed treatments tested and was close to that of the in furrow treatment (Sample W).

### EXAMPLE 5

This Example illustrates additional tests utilizing compositions of the invention.

Table 9 lists the compositions tested in this Example.

TABLE 9

| Sample # | Compositions | g a/100 kg seed | ga/hectre |
|---|---|---|---|
| X | None (control) | | |
| Y | imidacloprid | 500 | |
| Z | imidacloprid/abamectin | 500/100 | |
| AA | imidacloprid/abamectin | 500/0.15 mg | |
| BB | imidacloprid/thiodicarb | 500/1,000 | |
| CC | thiamethoxam/abamectin | 0.3 mg/0.15 mg | |
| DD | aldicarb | | 840 |

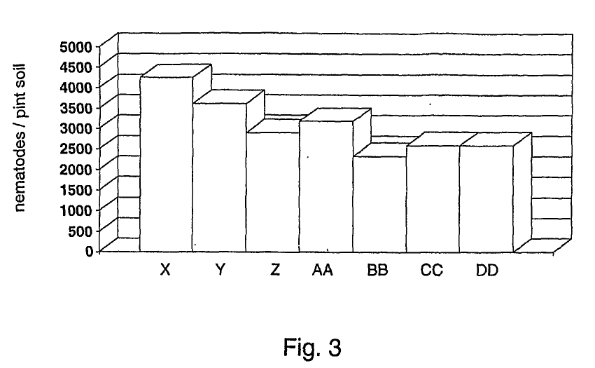

FIG. 3 shows that the composition of the invention (BB) gives the best reduction in reniform nematodes per pint of soil for cotton plants planted in soil having reniform nematode pressure.

FIG. 4 shows that the composition of the invention gave statistically fewer galled roots compared to untreated cotton plants or cotton plants treated with imidacloprid alone.

FIG. 5 shows that the composition of the invention had fewer root knot nematodes per 500 cc of soil.

FIG. 6 shows that over 4 separate trials, the composition of the invention showed substantially fewer nematodes per cc of soil compared to untreated plants or plants treated with imidacloprid alone.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

1. A nematicidal composition, comprising:
(a) at least one carbamate; and
(b) at least one neonicotinoid and/or chloronicotinyle.

2. The composition of claim 1, wherein the carbamate is an oxime carbamate.

3. The composition of claim 2, wherein the carbamate is thiodicarb.

4. The composition of claim 1, wherein the neonicotinoid and/or chloronicotinyle is selected from the group consisting of nitroguanidines, nitromethylenes, cyanamidines, chloropyridines, chlorothiazoles, tetrahydrofuranes, and mixtures thereof.

5. The composition of claim 1, wherein the neonicotinoid and/or chloronicotinyle is a nitroguanidine.

6. The composition of claim 5, wherein the neonicotinoid and/or chloronicotinyle is selected from the group consisting of imidicloprid, thiamethoxam, clothianidin, dinotefuran, and mixtures thereof.

7. The composition of claim 1, wherein the neonicotinoid and/or chloronicotinyle comprises imidicloprid and clothianidin.

8. The composition of claim 1, wherein the neonicotinoid and/or chloronicotinyle is imidicloprid.

9. The composition of claim 1, wherein the composition is an aqueous composition comprising (a) carbamate in the range of 1 to 1,000 g a/l and (b) neonicotinoid and/or chloronicotinyle in the range of 1 to 1,000 g a/l.

10. The composition of claim 1, wherein the carbamate (a) comprises thiodicarb in the range of 1 to 1,000 g a/l and the neonicotinoid and/or chloronicotinyle (b) comprises imidicloprid and/or clothianidin in a range of 1 to 1,000 g a/l.

11. The composition of claim 1, wherein the carbamate (a) comprises thiodicarb in the range of 100 g a/l to 600 g a/l and the neonicotinoid and/or chlorinicotinyle (b) comprises imidacloprid in the range of 200 g a/l to 800 g a/l.

12. The composition of claim 1, wherein the carbamate (a) comprises thiodicarb in the range of 100 g a/l to 600 g a/l and the neonicotinoid and/or chlorinicotinyle (b) comprises imidacloprid in the range of 200 g a/l to 800 g a/l and clothianidin in the range of 100 g a/l to 300 g a/l.

13. A method of controlling nematodes comprising applying a composition of claim 1 to a plant.

14. The method of claim 13, comprising applying the composition from two or more separate solutions.

15. The method of claim 13, comprising applying the composition to provide thiodicarb in the range of 50 to 900 g per 100 Kg of plant parts and 50 to 500 g imidacloprid per 100 Kg of plant parts.

16. The method of claim 15, further including applying the composition to provide clothianidin in the range of 50 to 400 g per 100 Kg of plant parts.

17. A method of treating seeds for the control of nematodes, comprising applying a composition according to claim 1 to seeds.

18. The method of claim 17, comprising applying the composition from two or more separate solutions.

19. The method of claim 17, comprising applying the composition to provide thiodicarb in the range of 50 to 1000 g per 100 Kg of plant parts and 50 to 500 g imidacloprid per 100 Kg of seeds.

20. The method of claim 19, further including applying the composition to provide clothianidin in the range of 50 to 400 g per 100 Kg of seeds.

21. A method of increasing yield, comprising applying a composition according to claim 1 to a plant.

22. A nematicidal composition, comprising:
(a) at least one carbamate;
(b) at least one neonicotinoid; and
(c) abamectin.

23. The composition of claim 22, wherein the carbamate comprises thiodicarb and the neonicotinoid comprises imidacloprid.
